(19) United States
(12) Patent Application Publication
(10) Pub. No.: US 2021/0086900 A1
(43) Pub. Date: Mar. 25, 2021

(54) CARGO MANAGEMENT SYSTEM FOR LOADING AND UNLOADING CARGO INTO AND OUT OF A CARGO AREA OF A MOBILE OBJECT

(71) Applicant: TELAIR INTERNATIONAL AB, Lund (SE)

(72) Inventor: Örjan Christoffersson, Lund (SE)

(21) Appl. No.: 16/772,117

(22) PCT Filed: Nov. 28, 2018
(86) PCT No.: PCT/EP2018/082855

§ 371 Date: Jun. 11, 2020

(30) Foreign Application Priority Data
Dec. 15, 2017 (DE) 10 2017 130 163.1

(51) Int. Cl. B64D 9/00; B60P 1/38; B64F 1/32

(52) U.S. Cl. CPC B64D 9/00; B64D 2009/006; B64F 1/322; B60P 1/38

(57) ABSTRACT

A cargo management system is proposed for loading and unloading cargo into and out of a cargo area of a mobile object, it being possible for loose piece goods to be present individually or gathered together in a container-like receptacle. The cargo management system consists of a conveying device arranged outside the cargo area, a cargo handover module arranged in the entrance region of the cargo area of the mobile object, and an intermediate conveying device, which is arranged downstream from the cargo handover module in the cargo area.

The present invention relates to a cargo management system for loading and unloading cargo, in the form of pallets, containers and loose piece goods such as bags, suitcases, packages and the like, into a cargo area, according to claim 1.

The number of persons conveyed in short-distance and long-distance travel is constantly increasing. Thus, for example, the number of flight passengers worldwide from Germany alone rose to over 81 million in 2014 (source: Destatis, 2017). The situation is similar for the number of persons conveyed long-distance by other means of travel, for example by rail or ship.

With the increasing number of persons to be conveyed, the number of pieces of passengers' luggage to be conveyed is also increasing. There are thus high requirements on luggage management so as to be able to provide rapid, seamless air travel. In particular, luggage management has to be based individually on the requirements of the aircraft type used in each case.

A distinction is made between two main classes of aircraft type in this regard.

These are, on the one hand, wide-body aircraft such as the Boeing 747, Boeing 767, Airbus A340 or Airbus A380. This type of aircraft, which are only economically viable on routes with a correspondingly high number of passengers, have more than five meters fuselage diameter and at least two gangways in the passenger cabin, which may also have a second level.

By contrast, there are the significantly smaller narrow-body aircraft, including the Boeing 727, 737 and 757 and the four model series of the Airbus A320 family, which have the same standardised fuselage diameter. As a result of their construction, these smaller aircraft offer less passenger comfort, because the cabin is perceived as cramped and its walls are strongly curved and can create the feeling of a tube, in particular in planes having a long fuselage.

Wide-body aircraft are designed in such a way that, as well as a large, sometimes multi-floor passenger cabin, they have a large cargo area, in which ULDs (unit load devices) can be received. ULDs are pallets and containers which are used to load luggage, cargo and post, bundled into units, onto wide-body aircraft and a few narrow-body aircraft, if these have the required transport system for pallets and aircraft containers, which consists of a combination of roller plates and corresponding locking devices in the cargo area, by means of which the ULDs can be positioned in the cargo area and secured against moving.

These ULDs are certified containers, pallets or nets, which have to withstand particular forces (for example an upward force of 9826 lb or approximately 4457 kg over a time span of 3 seconds for an LD3 container secured to the floor plate at 4 points). The certification standards most commonly used worldwide are the Technical Standards Order (TSO) of the FAA and the ETSO C90c of the EASA, although countries such as China and Australia have additional standards for certifying ULDs.

These containers certified by the FAA or EASA are closed receptacles consisting of aluminium sheets comprising profile frames or a combination of aluminium (frame) and plastics material (walls), and may also, depending on the type of goods located therein, have incorporated cooling units. For this purpose, these ULD containers are often internally equipped with eyes so as to be able to fix heavy cargo units and dangerous goods shipments.

Although the use of ULDs results in fewer units having to be loaded, and saves on ground staff, time and expense for handling companies since the ULDs can be conveyed rapidly in and out of the cargo area, the use of these ULDs is not possible in all narrow-body aircraft.

For example, the Boeing 737 is a narrow-body aircraft whose cargo spaces are not configured for transporting ULDs. In particular, this aircraft type does not have authorisation for the required transport system for pallets and aircraft containers, along with the corresponding locking devices in the cargo area by means of which the ULDs can be secured against movement.

Thus, in most narrow-body aircraft, because of the lack of positioning and safety options for ULDs, it is necessary to perform loading and unloading manually, in that ground staff convey travellers' luggage etc. piece by piece from apron vehicles via a conveyer belt to the cargo area opening and receive it there. In the relatively small cargo area, at a height of less than 1.30 metres, ground staff then takes over the luggage, which is pushed over the cargo area floor by the employee at the cargo area entrance, and arranges the luggage in the cargo area in cramped conditions.

This is associated with a high outlay in terms of ground staff and time, and is damaging to the health of the ground staff because of the predominantly kneeling, unfavourable work conditions, sometimes lead to high downtime, further increasing the loading and unloading times.

Moreover, high standing times for loading are unloading mean lost time in which the airline cannot generate revenue.

Therefore, the object of the present invention is to provide an option for accelerating and facilitating the loading and unloading of cargo in the form of pallets, containers and loose piece items such as bags, suitcases, packages and the like, in particular in narrow-body aircraft, without posing a risk to the safety of the means of transport to be loaded or of the staff working with it.

This object is achieved by the cargo handover module according to claim 1.

The invention thus proposes a cargo management system for loading and unloading cargo into and out of a cargo area of a mobile object, the cargo being in the form of pallets, containers and loose piece items such as bags, suitcases, packages and the like. The loose piece items may in particular be in the form of individual luggage items or be gathered together into a container-like receptacle. The cargo management system for loading and unloading cargo into and out of a cargo area of a mobile object comprises:

a conveying device, which is arranged outside the cargo area and conveys the cargo to an entrance region of the cargo area of the mobile object; a cargo handover module arranged in the entrance region of the cargo area of the mobile object, the cargo handover module accepting the supplied cargo and passing it on into the cargo area, the cargo being orientatable on the cargo handover module before being passed on into the cargo area; and at least one intermediate conveying device, arranged downstream from the cargo handover module in the cargo area, for conveying the cargo onwards within the cargo area.

This cargo handover module comprises: a base unit, which can be arranged in the entrance region of a cargo area and comprises four edge regions which span a transport area between them, at least two input elements, which are arranged in a first edge region of the four edge regions of the base unit and by means of which the cargo can be received in the entrance region of the cargo area and conveyed onwards to the base unit, at least two output elements, which are arranged in a second edge region of the four regions of the base unit, preferably offset through 90° from the first edge region, and by means of which the cargo can be conveyed onwards from the base unit into the cargo area, a plurality of transport devices, which are arranged integrally in the base unit, distributed over the transport area on the upper face of said unit, and by means of which the cargo supplied via the input elements can be orientated and passed on to the output elements, and guide elements, which are arranged in a third and fourth edge region of the four edge regions of the base unit so as to prevent the cargo from moving out over the transport area when being supplied to the transport area.

The cargo handover module is distinguished in that it is produced in a lightweight construction, and weight can thus be saved by comparison with conventional DWUs. As a result, it is possible to install the cargo handover module long-term on corresponding mountings or rails in the entrance region of the cargo area or to guide it over the apron to the aircraft short-term for loading or unloading, to engage it with the cargo area, and subsequently to remove it again after the loading or unloading process. It is this flexibility of rapidly installing the module as required, effectively arranging it in the cargo area by plug-and-play, and then removing it again, which is not possible with conventional DWUs, since as mentioned at the outset these are formed correspondingly heavy.

The container-like receptacle comprises: a support structure comprising a base part and two side elements arranged thereon and positioned opposite one another, a shell element, which is connectable to the support structure in such a way that the support structure and the shell element connected thereto define between them a space, enclosed on at least five sides, for receiving the loose piece items, the support structure and/or the shell element being configured in such a way that, if a limit defined in advance on a force acting on the support structure and/or the shell element is exceeded, the support structure and/or the shell element release the space enclosed thereby, and thus enable relative mobility of the piece items received in the space, with respect to one another and to the container-like receptacle and an environment surrounding it, which is equal to the mobility of piece items which are not received in the container-like receptacle.

The cargo management system thus comprises a plurality of cooperating transport units or modules, making it possible to reduce the loading and unloading time. In addition, a container-like receptacle is provided, by means of which the luggage, which otherwise is present as loose piece items, can be introduced into the cargo area while gathered together. As a result of the arrangement according to the invention of a conveying device arranged outside the cargo area, which conveys the luggage to the cargo area and hands it over to a cargo handover module therein, where the luggage is orientated and conveyed further into the cargo area on an intermediate conveying device, it is possible for the first time to load the luggage into the cargo area and unload it again on the reverse path with virtually no involvement of ground staff, preferably in at least partially automated manner. In particular, according to the invention, it is possible for the entire loading and unloading process to be controlled from outside the cargo area. Thus, only a very small number of workers, who can monitor the loading and unloading and intervene if necessary, is required. As a result of the use of the container-like receptacle, in which the luggage which would otherwise be loose is received gathered together, further time can be saved, since instead of a large number of individual pieces of luggage only these containers still have to be brought into the cargo area.

So as to take into account the problem that the use of containers was not possible thus far because of the lack of fastening options, in particular in narrow-body aircraft, since the certification standards indicated above cannot be met, in the cargo management system a type of container is provided whose partially applied surface load does not exceed a locally assigned maximum safe load for the aircraft construction under a permissible total load under predetermined loading scenarios for flight operation, in other words which because of its properties is not to be considered a container within the meaning of the aforementioned certification stands and in particular can even be used in narrow-body aircraft which do not have a transport system for pallets and aircraft containers, said system potentially comprising corresponding locking mechanisms in the cargo area by means of which ULDs of this type can be positioned and secured against movement.

Thus, using the cargo management system according to the invention, the container-like receptacle can be handled similarly to ULDs during loading and unloading. However, if a limit defined in advance on a force acting on the support structure and/or shell element of the container-like receptacle is exceeded, for example if the aircraft enters turbulence and suddenly drops, the container “breaks” apart, causing the luggage received therein to be released and to be able to spread in the cargo area, in such a way that a locally assigned maximum safe load for the aircraft construction is not exceeded.

However, the luggage stowed in the receptacle continues to move under mass inertia, causing a force acting in the original direction of movement to be applied to the support structure and/or the shell element.

This inertia force acts on the receptacle, together with the reaction force generated upon the abrupt braking of the receptacle and acting counter to the inertia force, causing a total force to be applied to the container-like receptacle. If this total force exceeds the limit defined in advance on the maximum admissible force acting on the support structure and/or the shell element, the container “breaks” open, releasing the space enclosed thereby and enabling mobility of the piece goods received therein with respect to one another and to the receptacle and the environment surrounding it.

In other words, the luggage tumbles freely through the cargo area as if it had never been received in a receptacle, making it possible reliably to prevent damage to the cargo area structure.

However, since scenarios of this type do not occur during most flights, the luggage remains in the container-like receptacle, and can be unloaded after landing in a reverse manner by comparison with the above-described loading process. Time and staff can thus be saved, reducing the costs for the airlines.

The cargo management system according to the invention makes much simpler loading and unloading possible, together with a significant time saving and a noticeably reduced burden on the ground staff involved, making it possible to reduce idle time and downtime, ultimately leading to a further cost reduction.

Advantageous developments of the cargo management system form the subject matter of the dependent claims.

The conveying device arranged outside the cargo area may thus be a conveying vehicle or a variable-length conveyor belt. The luggage can thus be brought rapidly from the storage or consignment location, for example the check-in at the airport, to the aircraft. For example, the pre-packaged luggage may be brought on a luggage vehicle to the apron, from where it is subsequently automatically conveyed into the cargo area by means of a conveyor belt on the conveying vehicle. In an alternative embodiment, a variable-length conveyor belt may reach directly from the storage or consignment location, for example the check-in at the airport, to the aircraft, and the luggage may be brought into the cargo area in this way.

The input elements in the first edge region and the output elements in the second edge region may be formed in the manner of rollers, and the transport devices which are arranged distributed over the transport area of the base unit may be formed in the manner or rollers or balls. In addition, further transport means in the form of rails or the like may be arranged on the transport area. The input elements, the output elements and/or the transport devices may be configured in such a way that they make it possible for the cargo to be received, orientated and passed on manually and/or with the assistance of motor power, preferably automatically.

The luggage can thus be orientated by ground staff or automatically in a particularly simple manner, virtually without resistance, as a result of the ball-bearing-like mounting, and subsequently be passed on further into the cargo area or from said area to vehicles positioned on the apron. As a result, the force and time expenditure can be noticeably reduced.

In the transport area of the base unit, at least two drive units facing in different directions may be arranged, preferably offset through 90° with respect to one another, which have roller-like conveyor elements which are driveable by a motor arranged integrally in the base unit, the drive units being arranged sunk into the transport area of the base unit and being able to be lifted again by a lifting device to pass on the cargo, in such a way that the conveying elements protrude from the transport area of the base unit so as to take over the cargo from the input elements by motor power, convey it onwards onto the transport area of the base unit, and from there, after the cargo is orientated by means of the transport devices, to output it into the cargo space, preferably to the intermediate conveying device arranged therein, via the output elements, preferably in an accelerated manner.

The provision of additional drive units, which are sunk into the transport area in the idle state and can be lifted therefrom as required, makes it possible to pass cargo on in and out of the cargo area in an assisted manner. This is advantageous in particular for heavy and cumbersome items, since not only does this reduce the physical effort from the staff occupied with loading, but at the same time the risk of injury can be reduced. Without assistance of this type, in particular for heavy, cumbersome items, the risk of back injury is relatively high. As a result of the additional drive units, idle times due to illness/injury can thus also be reduced. Moreover, the accelerated delivery of the cargo makes it possible to minimise the distances between the items to be loaded in the cargo area, making it possible to reduce undesired slippage of the cargo during take-off or in the event of turbulence during the flight.

The motors, arranged integrally in the base unit, and the lifting device may be actuable by means of a control unit, which is arranged integrally in the base unit and can be connected in a wired or wireless manner to a device provided in the cargo area.

The provision of a control unit which can be connected in a wired or wireless manner to a device of the aircraft provided in the cargo area makes possible combined control not only of the cargo handover module but also of the intermediate conveying device present in the cargo area, making it possible to reduce the time for loading and unloading processes, since it is no longer necessary to control the individual devices separately. Rather, it is possible to control a large number of modules integrally using a single control unit. Since the cargo handover module is preferably connected in such a way that a connection is established to the aircraft-internal systems in the cargo area, for example a cargo balance display, the power supply etc., it is not necessary to provide separate power lines etc. via which the cargo handover module can be powered.

At least one of the guide elements arranged in the third and fourth edge region of the four edge regions of the base unit may have control elements, which are arranged in recesses formed in the guide element and which are protected by a protective wall formed by a part of the guide element facing the transport devices, the control unit being operable by means of the control elements so as integrally to control the input and output elements, the transport devices, the drive units and further devices present in the cargo area.

So as to be able to operate the control unit as simply as possible, one of the guide elements may be formed in such a way that it comprises control elements such as operating buttons, a joystick etc. formed integrally therein. To avoid injury to an individual operator standing or sitting in the entrance region of the cargo when the control elements are actuated, for example because he catches his hand on luggage running on the transport area, the control elements are arranged behind a part of the guide rail which serves as a protective wall. This highly integral configuration thus makes it possible to control the control unit without difficulty while it is also possible to avoid injury to the operator during operation.

The control unit may be actuable by means of a control unit, which is arranged preferably removably in the cargo area and/or carried by an operator so as to give instructions to the control unit in a wired and/or wireless manner, preferably from outside the cargo area.

The provision of a removable control unit, in addition or as an alternative to the integrally formed control elements, makes it possible further to simplify the loading and unloading using the cargo management system according to the invention.

It is thus possible in particular to carry out both the loading and the unloading without staff having to kneel in the region of the cargo room entrance for this purpose. Instead, by means of the control unit, the associated components or modules of the cargo management systems can be controlled remotely, in that the staff stand for example in the vicinity of the cargo area entrance on the apron vehicle when the control unit is connected to the cargo handover module and the control unit via a cable, for example a coiled cable. For a wireless formation of the control unit, the staff may even stand on the apron, making it possible to reduce a potential risk of injury virtually to zero, since for example it is not possible to fall from the conveying vehicle as a result of inadvertent movement. If standardised NFC and/or Bluetooth protocols are used, it is moreover possible to pair a smartphone having a corresponding app with the cargo handover module and subsequently to use this for remote control, in such a way that the number of required components can be further reduced. The loose luggage and container-like receptacle can thus be received at a safe distance from the apron, conveyed via the conveying device to the cargo handover module and orientated there. Subsequently, the cargo can be passed on to the intermediate conveying device covering the cargo area floor, by means of which it can subsequently be brought to its final storage place.

By means of the output elements, cargo can be received from the cargo area, preferably the intermediate conveying device arranged therein, and conveyed onwards to the base unit, it being possible for the supplied cargo to be orientated there by means of the transport device and passed on to the input elements, and subsequently to be conveyed via the entrance region of the cargo area to the conveyor device arranged outside the cargo area by means of the input elements.

This analogously makes simplified and accelerated loading and unloading possible, with all the advantages cited above.

The intermediate conveying device arranged in the cargo area may be a roller plate, a motor-driven conveyor belt covering the floor of the cargo area in a planar manner, or a combination thereof.

As a result of the use of an intermediate conveying device, sold for example by the Applicant under the name sliding carpet©, it is no longer necessary for workers to kneel in the cargo area to load the cargo, in particular the loose cargo such as suitcases etc. Rather, the luggage can—preferably at least partially automatically—be orientated by the cargo handover module and deposited on the intermediate conveying device, which subsequently brings the luggage deeper into the cargo area, for example continuously or incrementally. This makes it possible to save on staff and time, thus leading to a noticeable reduction in idle time and costs.

At the support structure, formed for example in a sandwich construction and/or honeycomb formation, and/or the shell element of the container-like receptacle, at least one holding element may be formed, by means of which the support structure and the shell element are interconnected. Further, the support structure may be stackable when unloaded, in other words without the luggage and shell element.

As a result, it is possible to connect the shell element and the support structure in a rapid and simple manner, possibly even with only one hand. For example, a strap-like holding element may be guided through a corresponding loop, or the connection can be produced by hook-and-loop fastening. Depending on the application of the container-like receptacle and the configuration of the shell element used therein, more or fewer holding elements of this type are provided, which may consist of different combinations of fastening means such as straps, eyes, hooks, hook-and-loop strips, clips etc. In addition, empty receptacles may be stacked in a compact manner and transported in predetermined lot sizes or held in reserve at the place of use.

The shell element may consist of at least two parts, which are interconnected by means of a connecting element. The shell element may enclose the support structure in a wall-free region spanned between the base part and the side elements, so as to form the space enclosed by the support structure and the shell element. Depending on the field of use, different materials may be used for the shell element. Thus, the shell element may for example consist of a waterproof, tear-resistant and/or fire-resistant fabric, a net, a paper-like, cardboard-like and/or plastics-like material.

As a result of the use of a two-part shell element, it is advantageously possible to load a partially complete container, which is already enclosed by walls at the lower face, the rear face, the two outer faces and the upper faces, and subsequently merely to close the free end used for the loading.

Thus, for example in large warehouses or airports, a pre-established number of prepared containers may be provided, which are then loaded and subsequently closed, for example during the handover to another station. As a result of the use of a connecting element in the manner of a lock, quick connector or clip, it is additionally possible to interconnect the two parts of the shell element in a rapid and simple manner.

The container-like receptacle may further comprise at least one release device, which is arranged between the support structure and the shell element or between the two parts of the shell element and is configured in such a way that it opens if the limit defined in advance on the force acting on the support structure and/or the shell element is exceeded, and releases the connection between the support structure and the shell element or the connection between the at least two parts of the shell element. This release device may be formed in the holding element or in the connecting element.

The provision of a release device of this type ensures that the connection between the support structure and the shell element or the connection between the two parts of the shell element reliably breaks when the admissible limit is exceeded, in such a way that the space enclosed thereby is released and the luggage can fall out of the receptacle free and unimpeded. If the release device is formed in the holding element, the connection between the shell element and the support structure can reliably be opened if the admissible limit is exceeded. If the release device is formed in the connecting element which connects the at least two parts of the shell element, it is additionally advantageously possible, if the admissible limit on the force acting on the support structure and/or the shell element is exceeded, for the part of the shell element on which the weight of the pressing luggage acts to fold out from the container-like receptacle in the direction of the force applied by the luggage and for the luggage to come to lie flat thereon, as on a carpet.

Since the cargo management system according to the invention additionally has the intermediate conveying device covering the floor of the cargo area, by means of which the loose luggage and the container-like receptacle are deliver into the cargo area interior, the luggage released from the container and lying on the “carpet” formed by the shell element can be moved by the intermediate conveying device while gathered together, in such a way that even after the luggage is released from the container, for example as a result of turbulence during the flight, it remains possible to save time during loading and unloading.

The container-like receptacle may comprise buffer elements, which enclose upper edges of the side elements of the container-like receptacle in the width direction of the support structure, and at least one transverse strut, which is arranged extending in the width direction of the support structure on upper edges of the side elements in such a way that the transverse strut interconnects the side elements, the shell element being connectable to the support structure in such a way that the shell element extends over the transverse strut so as to be supported by said strut, in such a way that the support structure and the shell element connected thereto together define a completely enclosed space.

As a result of the use of buffer elements, for example of foamed plastics material or the like, damage to the shell element from the edges of the support structure can be prevented. Moreover, as a result of the provision of at least one transverse strut, which extends transversely over the support structure so as to interconnect the side elements, the shell element can be supported from below, meaning that individual pieces of luggage, which for example are only handed in on the apron during boarding, can optionally still be laid on the already closed receptacle.

The base part and/or the side elements of the support structure of the container-like receptacle may be configured in such a way that they can receive and retain escaped liquids in the space, preferably in an amount of several millilitres to a few litres, in particular three litres.

Since the base part and/or the side elements of the support structure can receive at least small amounts of liquid, it is possible to receive escaping liquids such as drinks, cosmetic solutions etc. in the cargo area, making it possible to avoid or at least speed up cleaning the cargo area. Since the liquids can be received by and retained in the container, subsequently soiling of the luggage which does not come into direct contact with the liquids can additionally be avoided, for example during unloading from the cargo area. As a result of the formation of the base part and/or the side elements of the support structure in such a way that these can receive and retain liquids, it is additionally possible to prevent the cargo area structure from being damaged by escaping corrosive liquids.

The container-like receptacle may additionally comprise handle elements which are attached to the base part and/or the side elements of the support structure and make manual orientation of the container-like receptacle possible. For example, traction cables, handle loops or handgrips may be provided by means of which the container can be pulled or pushed to the desired location and orientated there.

In the support structure and/or the shell element, means may be formed by means of which visual and/or electronic checking and assignment of the device, preferably by near-field communication, are possible. This makes it possible to establish the content and destination of the container-like receptacle rapidly.

According to the invention, the mobile object may be a narrow-body aircraft, and the limit defined in advance on the force acting on the support structure and/or the shell element of the container-like receptacle may be less than a maximum admissible load, acting in any direction, which can be received in the cargo area of the narrow-body aircraft, and in particular does not exceed 300 N.

The container-like receptacle is configured in such a way that the limit defined in advance on the force acting on the support structure and/or the shell element is less than a maximum admissible force, acting in any direction, which can be received in the cargo area of the narrow-body aircraft. In empirical tests, it has been found that this is a value in the range of 200 N to 400 N. Taking into account the above-mentioned certification standards, the container-like receptacle is configured in such a way that the limit defined in advance does not exceed 300 N, ensuring that the surface load partially applied by the container-like receptacle under an admissible total load does not exceed the locally assigned maximum safe load for the aircraft construction in predetermined loading scenarios in flight operation.

In other words, with the container-like receptacles used in the cargo management system according to the invention for receiving loose piece goods such as bags, suitcases, packages and the like, it can be ensured in all conceivable flight scenarios that as a result of the selected value the container can be prevented from breaking open undesirably, while the value is simultaneously such that damage to the cargo area structure is prevent in every case.

The container-like receptacle may be used for storing loose piece items received therein in a cargo area of the narrow-body aircraft, and the base part and the side elements connected to the base part may be configured in such a way that they follow the contour of the cargo area cross section. This makes maximum exploitation of the available area in the cargo area possible.

The cargo handover module, the intermediate conveying device and/or the container-like receptacle may be formed at least in part from a fibre-reinforced plastics material such as a glass-fibre composite material, a carbon-fibre composite material, Kevlar, or combinations thereof. As a result, the weight of the modules, located in the cargo area, of the cargo management system according to the invention can be greatly reduced, conversely making it possible to increase the useful load.

The invention thus provides an option for accelerating and facilitating the loading and unloading of cargo in the form of pallets, containers and loose piece items such as bags, suitcases, packages and the like, including in narrow-body aircraft, without posing a risk to the safety of the means of transport to be loaded or of the staff working with it.

### BRIEF DESCRIPTION OF THE DRAWINGS

The features and advantages and the technical and economic significance of example embodiments of the invention are described in the following with reference to the accompanying drawings, in which:

FIG. 1 is a schematic view of a cargo management system according to the invention for loading and unloading cargo into and out of a cargo area of a mobile object; and

FIG. 2 is a schematic drawing of an embodiment of a container-like receptacle, which shows in the partial views 1 to 4 how the received piece goods are released when the limit on the force acting on the support structure and/or the shell element of the container-like receptacle is exceeded.

### DESCRIPTION OF EMBODIMENTS

In the following, an embodiment of the cargo management system according to the invention for loading and unloading cargo into and out of a cargo area of a mobile object is described with reference to the drawings.

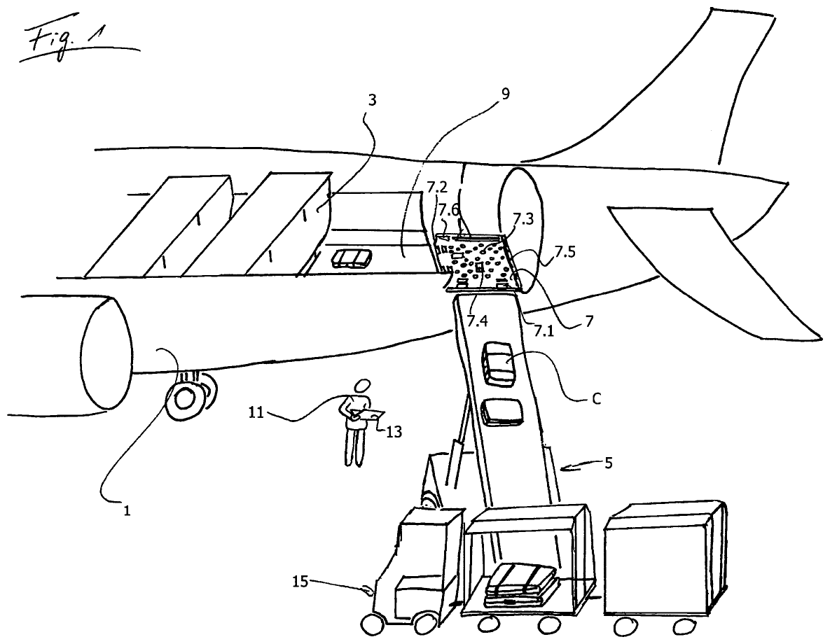

FIG. 1 schematically shows an embodiment of a cargo management system according to the invention for loading and unloading cargo into and out of a cargo area of a mobile object 1.

In the embodiment shown here, the cargo management system according to the invention is used in an application in a narrow-body aircraft, which is configured with a relatively small cargo area, generally only somewhat over one metre high, below the rows of seats.

As is shown schematically in FIG. 1, the aircraft 1 is located in its parking position on the apron.

The cargo area hatch (not shown) is open, and via waiting transport vehicles 15 luggage C supplied from the counter is transported via a conveying device 5 (a conveyor belt arranged on a further apron vehicle) into the entrance region of the cargo area.

There, said luggage arrives at a cargo handover module 7, installed in the entrance region, by way of which the loose luggage C and other cargo, for example container-like receptacles 3, can be conveyed onwards into the cargo area. The container-like receptacles 3 are formed in such a way that they make it possible to receive and pass on the luggage while it is gathered together, but break open if a limit on the force acting on the support structure 3.1 of the receptacles and/or on the shell element 3.2 connected thereto is exceeded, and release the loose luggage C received gathered together therein.

The cargo handover module 7 has rollers, referred to as input elements 7.1, in the region of the cargo area opening, which receive the cargo supplied using the conveyor belt of the apron vehicle and guide it onwards onto a transport area, on which the ball-like transport devices 7.3 are formed.

In particular when container-like receptacles 3 or the like are being handled, drive units 7.4 provided in the cargo handover module 7, which are sunk into the transport area when not in use, are lifted.

Motor-driven rollers formed on the drive units 7.4 can subsequently pull the receptacles 3 and the like, in a power-assisted manner, onto the transport surface, where the cargo can subsequently be orientated.

For passing the cargo on into the cargo area, further drive units 7.4, preferably arranged offset through 90 degrees, and rollers, referred to as output elements 7.2, are provided, which, after the cargo is orientated by way of the transport rollers 7.3, guide it onwards into the cargo area in a motor-assisted manner.

To prevent the structure of the cargo area from being damaged as a result when cargo is conveyed out over the transport area of the cargo handover module 7 during loading and/or unloading, guide elements 7.5 and 7.6 are arranged on the cargo handover module 7, and restrict the movement path of the cargo.

For transporting the cargo handed over by the cargo handover module 7 onwards into the cargo area, an intermediate conveying device 9 is provided.

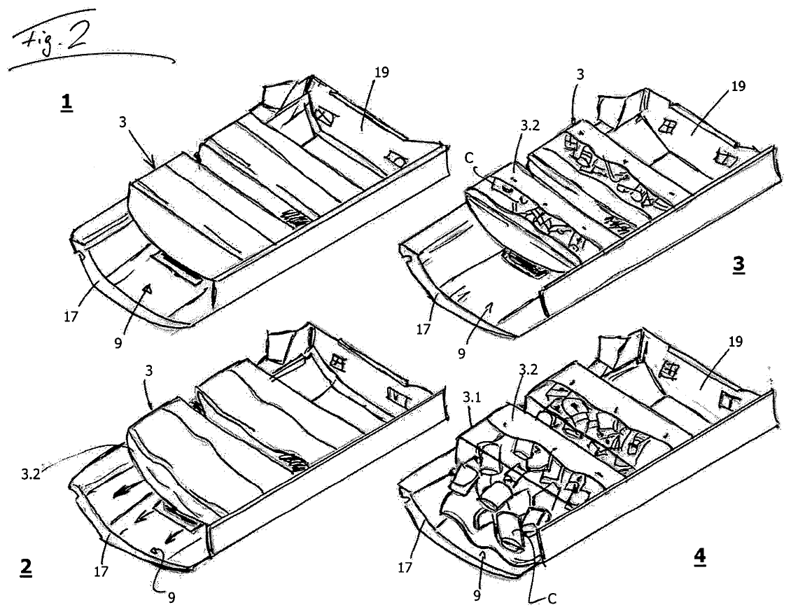

The intermediate conveying device 9 in this embodiment comprises a conveyor belt, which covers the floor of the cargo area and parts of the cargo area side walls, and thus follows the contour of the cargo area, as is shown in particular in FIG. 2.

The conveyor belt of the intermediate device 9, which is used by the Applicant under the name sliding carpet©, is borne and reinforced by guide elements, which are arranged along the cargo area floor—in the longitudinal direction of the cargo area—the conveyor belt extending above and below these guide elements. To save weight, the guide elements and the receiving units 17 in the region of the cargo handover module 7 and the head end 19, pointing towards the cockpit, of the intermediate conveying device 9 are made of a fibre composite material.

The loaded luggage is laid on the head end 19, pointing towards the cockpit, of the intermediate conveying device 9, said end being formed substantially as a wall directed vertically from the conveyor belt towards the cargo area ceiling.

In particular, the luggage, in other words the loose piece goods C in the form of suitcases and the like, and the container-like receptacles 3 are outputted, by means of the output elements 7.2, via the ball-like transport devices 7.3 onto the intermediate conveyor device 9, which subsequently guides the luggage onwards into the cargo area interior.

So as to leave as much stowing space as possible unused, and thus to minimise the free space between the luggage to be loaded, the cargo consisting of the loose piece goods C and container-like receptacles 3 can be accelerated by the output elements 7.2 when being passed on from the cargo handover module 7 to the intermediate conveyor device 9, in such a way that the cargo comes to be positioned tightly together on the conveyor belt of the intermediate conveying device 9.

So as to reduce the burden on the staff entrusted with loading and unloading, operating or control elements are formed in the guide element 7.5 on the side of the cargo handover module 7 facing the vehicle tail, and are protected by a protective wall, which is formed by a part of the guide element 7.5 itself which faces the transport devices 7.3.

By means of these control elements, a control unit provided in the cargo handover module 7 is provided, so as integrally to control at least the input and output elements 7.1, 7.2, the transport devices 7.3, the drive units 7.4 and the intermediate conveying device 9, and in a particularly preferred embodiment the conveying device 5 located outside the cargo area and optionally further devices.

During loading and unloading, in an embodiment not shown here of the cargo management system according to the invention not shown here, only a single worker is present in the region of the cargo area entrance, who sits or kneels in the tail region of the aircraft behind the cargo handover module 7 and, by means of the control elements formed in the guide element 7.5 in the cargo handover module 7, integrally controls the conveying device 5 positioned outside the aircraft, the cargo handover module 7 and the intermediate conveying device 9. In this context, as a result of the cargo management system according to the invention, it is no longer necessary for the worker to lift the cargo himself and so forth. Rather, the worker controls the individual modules of the cargo management system by means of the control elements, the loading and unloading thus running in a largely automated manner.

This makes possible in particular a time-optimised, integrated control system, by means of which the cargo can be conveyed continuously or incrementally from the apron into the cargo area and from there back onto the apron.

In the particularly preferred embodiment shown in FIG. 1 of the cargo management system according to the invention, it is additionally possible for the first time to dispense with a worker in the cargo area completely.

Instead, the worker 11 is located at a safe distance from the input region of the cargo area on the apron, and holds in his hands a control unit 13 which, in the embodiment shown here, communicates wirelessly with the control unit provided in the cargo handover module 7.

The control unit 13 shown here is configured in such a way that it has access to cameras or sensors on the associated modules of the cargo management system, and it is thus directly detectable, in particular for the worker 11, if difficulties occur in the cargo area when the cargo is being loaded or unloaded, for example because it has not been possible to orientate suitcases or bags correctly.

In a particularly simply configured variant, the control unit 13 is not a specially formed element, such as a control console or the like, but rather a notebook, a tablet PC or even merely a smartphone, on which an app is executed which makes integral control of the cargo management system possible.

In an alternative embodiment not shown here, the worker 11 with the control unit 13 can also stand in the region of the ground vehicle 5, for example on a platform provided thereon, and thus look directly into the cargo area so as to be able to intervene immediately if this is required. In this context, the control unit 13 can then for example be connected to the cargo handover module 7 using a variable-length coiled cable so as to make it possible to input control commands.

As described at the outset, the container-like receptacles 3 are configured in such a way that they make it possible to receive and pass on the luggage while it is gathered together, but break open if a limit on the force acting on the support structure 3.1 of the container-like receptacles and/or on the shell element 3.2 connected thereto is exceeded, and release the loose luggage C received gathered together therein.

As a result, it is possible to prevent the maximum admissible surface load in the cargo area from being exceeded, in such a way that, even though no standard containers certified in accordance with the provision of the Technical Standards Order (TSO) C90c of the FAA or the ETSO C90c of the EASA are used in most narrow-body aircraft, since this aircraft type lacks the required transport system for pallets and aircraft containers having the corresponding locking devices in the cargo area, by means of which ULDs of this type can be secured against movement, the luggage can still be transported gathered together in container-like receptacles 3.

The principle addressed above of a collapsing receptacle (also referred to as a collapsible load device, CLD for short, to distinguish it from conventional ULDs) is shown schematically in FIG. 2, which shows, in views 1 to 4, how the container-like receptacle 3 opens if a limit defined in advance on a force acting on the support structure 3.1 and/or the shell element 3.2 is exceeded, and releases the content thereof—in other words the loose piece goods C received therein in the form of suitcases, bags etc.—over the cargo area floor.

View 1 of FIG. 2 shows a plurality of container-like receptacles 3, which are received in succession in a cargo area of the aircraft 1. The container-like receptacles 3 are positioned without additional securing on the intermediate conveying device 9 covering the cargo area floor, and are automatically conveyed onwards into the cargo area by said device. In this state, no force acts on the container-like receptacle 3 aside from its own weight and the weight of the received pieces of luggage.

View 2 shows how the luggage received in the container-like receptacle 3 presses against the front face of the shell element 3.2 and buckles it in the direction of the arrows, for example because the container-like receptacle 3 starts sliding during take-off and landing or during the fluid, for example as a result of occurring turbulences, as a result of the locking devices necessarily being absent in this aircraft type.

The sliding container-like receptacles 3 may for example get caught on the side wall of the cargo area or the upper edges of the intermediate conveying device 9, causing the sliding receptacles 3 to be abruptly braked and come to a standstill.

However, the luggage stowed in the receptacle 3 continues to move under mass inertia, causing a force, which acts in the original movement direction, to act on the support structure 3.1 and/or the shell element 3.2.

If a force (inertia force F_{T}) applied to the container-like receptacles 3 by the luggage—the suitcases, bags etc.—and the force (reaction force F_{R}) generated by the abrupt stop of the sliding container-like receptacle 3 and acting counter to the inertia force exceed a limit defined in advance on the maximum admissible force (admissible total force F_{G}) acting on the support structure 3.1 and/or the shell element 3.2, the container-like receptacle 3 breaks upon, since in this case the release device provided in the container-like receptacles 3 releases the interconnection of the two halves of the shell element 3.2, causing the two parts of the shell element 3.2 to be released from one another, as shown in view 3.

In this context, as a limit value, a value is taken which is composed of:
the reaction force (F_{R}) generated when a container-like receptacle 3 which has started sliding unsecured is abruptly stopped, for example because it is hanging on to the walls of the cargo area or to other cargo stowed in the cargo area, and is thus brought to a standstill,
and the inertia force (F_{T}) of the luggage C stowed in the container-like receptacle 3, said luggage initially continuing to move under mass inertia in the direction in which the container-like receptacle 3 has slid, and thus applying a force to the support structure 3.1 and/or the shell element 3.2, which acts in the original movement direction.

This inertia force F_{T} then acts, together with the reaction force F_{R} on the container-like receptacle 3 generated during the abrupt braking of the container-like receptacle 3 and acting counter to the inertia force F_{T}, causing a total force (F_{G}) to be applied to the container-like receptacle 3.

If this total force F_{G} exceeds the limit defined in advance on the maximum admissible force acting on the support structure 3.1 and/or the shell element 3.2, the container-like receptacle 3 thus “breaks” open, causing the space enclosed by the support structure 3.1 and the shell element 3.2 to be released and thus enabling mobility of the piece items C received in the space, with respect to one another and to the container-like receptacle 3 and the environment surrounding it.

In empirical tests, the limit on the maximum admissible force has been determined as a value of approximately 400 N, and in accordance with the embodiment under discussion, adhering to the certification standards for narrow-body aircraft and maintaining a sufficient safety margin, is determined so as not to exceed 300 N.

When the release device opens the connection between the two halves of the shell element 3.2 if the limit on the maximum admissible force is exceeded, the space enclosed by the shell element 3.2 and the support structure 3.1 is thus released, and the luggage C held therein falls out of the container-like receptacles 3 into the cargo area, where it is distributed on the intermediate conveying device 9, as shown in view 4.

Since in the cargo management system according to the invention the intermediate conveying device 9 has a conveyor belt driven by a motor and covering substantially the entire floor of the cargo area, the luggage C, which is no longer bundled in the container-like receptacle 3 and instead is distributed loose on the conveyor belt, is still conveyed to the cargo handover module 7 in a short time during unloading as a result of the intermediate conveying device 9, and from there, after orientation, is handed over to waiting transport vehicles 15 and the like, rapidly and largely without assistance from ground staff, by means of the conveying device 5.

Although the cargo management system for loading and unloading cargo into and out of a cargo area has been described in the above using the example of a narrow-body aircraft, the cargo management system is similarly applicable to other mobile objects which have a correspondingly formed cargo area.

For example, the cargo management system can be used for loading and unloading a cargo area with cargo in a lorry, a ship, a goods train etc. in which various types of cargo are to be transported and as little idle time as possible is desired for the loading and unloading process. Because of the particular requirements, however, the cargo management system for loading and unloading cargo into and out of a cargo area is preferably used in narrow-body aircraft, and makes it possible to modernise the loading and unloading process in such a way that idle times and costs can be minimised, while it is simultaneously possible at least to maintain the amount of stored cargo.

The invention thus proposes a cargo management system for loading and unloading cargo (C) into and out of a cargo area of a mobile object (1), it being possible for loose piece goods to be present individually or gathered together in a container-like receptacle (3). The cargo management system consists of a conveying device (5) arranged outside the cargo area, a cargo handover module (7) arranged in the entrance region of the cargo area of the mobile object (1), and an intermediate conveying device (9), which is arranged downstream from the cargo handover module (7) in the cargo area.

### LIST OF REFERENCE NUMERALS

1 Mobile object (narrow-body aircraft)

3 Container-like receptacle

3.1 Support structure

3.2 Shell element

5 Conveying device (ground vehicle)

7 Cargo handover module

7.1 Input elements

7.2 Output elements

7.3 Transport devices

7.4 Drive unit

7.5 Guide element

7.6 Guide element

9 Intermediate conveying device (sliding carpet)

11 Worker

13 Control unit

15 Luggage transporter

17 Receiving unit

19 Head end

C Loose piece goods

1. Cargo management system for loading and unloading cargo into and out of a cargo area of a mobile object, the cargo being in the form of pallets, containers and loose piece items such as bags, suitcases, packages and the like, it being possible for the loose piece items to be present individually or gathered together in a container-like receptacle, comprising:
a conveying device, which is arranged outside the cargo area and conveys the cargo to an entrance region of the cargo area of the mobile object;
a cargo handover module arranged in the entrance region of the cargo area of the mobile object, the cargo handover module accepting the supplied cargo and passing it on into the cargo area, the cargo being orientatable on the cargo handover module before being passed on into the cargo area; and
at least one intermediate conveying device, arranged downstream from the cargo handover module in the cargo area, for conveying the cargo onwards within the cargo area;
wherein the cargo handover module comprises:
a base unit, which can be arranged in the entrance region of a cargo area and comprises four edge regions which span a transport area between them,
at least two input elements, which are arranged in a first edge region of the four edge regions of the base unit and by means of which the cargo can be received in the entrance region of the cargo area and conveyed onwards to the base unit,
at least two output elements, which are arranged in a second edge region of the four regions of the base unit, preferably offset through 90° from the first edge region, and by means of which the cargo can be conveyed onwards from the base unit into the cargo area,
a plurality of transport devices, which are arranged integrally in the base unit, distributed over the transport area on the upper face of said unit, and by means of which the cargo supplied via the input elements can be orientated and passed on to the output elements, and
guide elements, which are arranged in a third and fourth edge region of the four edge regions of the base unit so as to prevent the cargo from moving out over the transport area when being supplied to the transport area,
wherein the container-like receptacle comprises:
a support structure comprising a base part and two side elements arranged thereon and positioned opposite one another,
a shell element, which is connectable to the support structure in such a way that the support structure and the shell element connected thereto define between them a space, enclosed on at least five sides, for receiving the loose piece items,
the support structure and/or the shell element being configured in such a way that, if a limit defined in advance on a force acting on the support structure and/or the shell element is exceeded, the support structure and/or the shell element release the space enclosed thereby, and thus enable relative mobility of the piece items received in the space, with respect to one another and to the container-like receptacle and an environment surrounding it, which is equal to the mobility of piece items which are not received in the container-like receptacle.

2. Cargo management system according to claim 1, wherein:
the conveying device arranged outside the cargo area is a conveying vehicle or a variable-length conveyor belt.

3. Cargo management system according to claim 1, wherein:
the input elements in the first edge region are formed in the manner of rollers,
the output elements in the second edge region are formed in the manner of rollers,
the transport devices which are arranged distributed over the transport area of the base unit may be formed in the manner or rollers or balls, and further transport means in the form of rails or the like are arranged on the transport area.

4. Cargo management system according to claim 1, wherein:
the input elements, the output elements and/or the transport devices are configured in such a way that they make it possible for the cargo to be received, orientated and passed on manually and/or with the assistance of motor power.

5. Cargo management system according to claim 1, wherein:
in the transport area of the base unit, at least two drive units facing in different directions are arranged, preferably offset through 90° with respect to one another, which have roller-like conveyor elements which are driveable by a motor arranged integrally in the base unit, the drive units being arranged sunk into the transport area of the base unit and being able to be lifted again by a lifting device to pass on the cargo, in such a way that the conveying elements protrude from the transport area of the base unit so as to take over the cargo from the input elements by motor power, convey it onwards onto the transport area of the base unit, and from there, after the cargo is orientated by means of the transport devices, to output it into the cargo space, preferably to the intermediate conveying device arranged therein, via the output elements, preferably in an accelerated manner.

6. Cargo management system according to claim 1, wherein:
the motors, arranged integrally in the base unit, and the lifting device may be actuable by means of a control unit, which is arranged integrally in the base unit and can be connected in a wired or wireless manner to a device provided in the cargo area.

7. Cargo management system according to claim 1, wherein:
at least one of the guide elements arranged in the third and fourth edge region of the four edge regions of the base unit may have control elements, which are arranged in recesses formed in the guide element and which are protected by a protective wall formed by a part of the guide element facing the transport devices, the control unit being operable by means of the control elements so as integrally to control the input and output elements, the transport devices, the drive units and further devices present in the cargo area such as the intermediate conveying device.

8. Cargo management system according to claim 1, wherein:
the control unit is actuable by means of a control unit, which is arranged preferably removably in the cargo area and/or carried by an operator so as to give instructions to the control unit in a wired and/or wireless manner, preferably from outside the cargo area.

9. Cargo management system according to claim 1, wherein:
by means of the output elements, cargo can be received from the cargo area, preferably the intermediate conveying device arranged therein, and conveyed onwards to the base unit, it being possible for the supplied cargo to be orientated there by means of the transport device and passed on to the input elements, and subsequently to be conveyed via the entrance region of the cargo area to the conveyor device arranged outside the cargo area by means of the input elements.

10. Cargo management system according to claim 1, wherein:
the intermediate conveying device arranged in the cargo area is a roller plate, a motor-driven conveyor belt covering the floor of the cargo area in a planar manner, or a combination thereof.

11. Cargo management system according to claim 1, wherein:
at the support structure and/or the shell element of the container-like receptacle, at least one holding element is formed, by means of which the support structure and the shell element are interconnected.

12. Cargo management system according to claim 1, wherein:
the shell element consists of at least two parts, which are interconnected by means of a connecting element.

13. Cargo management system according to claim 1, wherein:
the shell element encloses the support structure in a wall-free region spanned between the base part and the side elements, so as to form the space enclosed by the support structure and the shell element.

14. Cargo management system according to claim 1, further comprising at least one release device, which is arranged between the support structure and the shell element or between the two parts of the shell element and is configured in such a way that it opens if the limit defined in advance on the force acting on the support structure and/or the shell element is exceeded, and releases the connection between the support structure and the shell element or the connection between the at least two parts of the shell element, the release device being formed in the holding element or in the connecting element.

15. Cargo management system according to claim 1, further comprising buffer elements, which enclose upper edges of the side elements of the container-like receptacle in the width direction of the support structure.

16. Cargo management system according to c1aim 1, further comprising at least one transverse strut, which is arranged extending in the width direction of the support structure on upper edges of the side elements in such a way that the transverse strut interconnects the side elements, the shell element being connectable to the support structure in such a way that the shell element extends over the transverse strut so as to be supported by said strut, in such a way that the support structure and the shell element connected thereto together define a completely enclosed space.

17. Cargo management system according to claim 1, wherein:
the base part and/or the side elements of the support structure of the container-like receptacle are configured in such a way that they can receive and retain escaped liquids in the space, preferably in an amount of several millilitres to a few litres, in particular three litres.

18. Cargo management system according to claim 1, wherein:
the container-like receptacle additionally comprises handle elements which are attached to the base part and/or the side elements of the support structure and make manual orientation of the container-like receptacle possible.

19. Cargo management system according to claim 1, wherein:
the support structure is stackable.

20. Cargo management system according to c1aim 1, wherein:
in the support structure and/or the shell element, means are formed by means of which visual and/or electronic checking and assignment of the device, preferably by near-field communication, are possible.

21. Cargo management system according to c1aim 1, wherein:
the mobile object is a narrow-body aircraft, and the limit defined in advance on the force acting on the support structure and/or the shell element of the container-like receptacle is less than a maximum admissible load, acting in any direction, which can be received in the cargo area of the narrow-body aircraft, and in particular does not exceed 300 N.

22. Cargo management system according claim 21, wherein:
the container-like receptacle may be used for storing loose piece items received therein in a cargo area of the narrow-body aircraft, and the base part and the side elements connected to the base part may be configured in such a way that they follow the contour of the cargo area cross section.

23. Cargo management system according to c1aim 1, wherein:
the cargo handover module, the intermediate conveying device and/or the container-like receptacle are formed at least in part from a fibre-reinforced plastics material such as a glass-fibre composite material, a carbon-fibre composite material, Kevlar, or combinations thereof.
